(19) United States
(12) Patent Application Publication
(10) Pub. No.: US 2022/0376225 A1
(43) Pub. Date: Nov. 24, 2022

(54) Bonding Of Current Collector To Lithium Anode Of Solid-State Battery Using Metal Alloying

(71) Applicant: Apple Inc., Cupertino, CA (US)

(72) Inventors: Penchala N. Kankanala, Los Gatos, CA (US); Karl M. Brown, Los Gatos, CA (US); Alan A. Ritchie, Menlo Park, CA (US); Richard M. Mank, Cupertino, CA (US); Ulrich A. Bonne, Sunnyvale, CA (US); Korhan Demirkan, Santa Clara, CA (US)

(21) Appl. No.: 17/325,376

(22) Filed: May 20, 2021

(51) Int. Cl. H01M 4/139; H01M 4/66; H01M 4/525; H01M 4/04

(52) U.S. Cl. CPC H01M 4/139; H01M 4/661; H01M 4/525; H01M 4/0404; H01M 4/043; H01M 2004/029

(57) ABSTRACT

An all-solid-state battery cell has a cathode on which a cathode current collector is attached, a solid electrolyte deposited on the cathode opposite the cathode current collector, an anode comprising lithium deposited onto the solid electrolyte opposite the cathode, and an anode current collector bonded to the anode opposite the solid electrolyte with a bonding layer of a metal alloyed with the lithium.

### TECHNICAL FIELD

This disclosure relates to methods of bonding an anode current collector to lithium using metal alloying and solid-state batteries having an anode current collector bonded to lithium using metal alloying.

### BACKGROUND

For conventional lithium-ion batteries, cathode material and anode material are coated directly onto the respective current collectors. In all-solid-state batteries (ASSBs) using a free-standing cathode, such as a LiCoO₂ wafer, for example, the current collectors are attached to the respective cathode and anode. Conventional bonding methods include the use of adhesive and conductive films to attach the anode current collector to the lithium anode. There are disadvantages to using adhesive and conductive films that ultimately negatively impact cell performance.

### SUMMARY

Disclosed herein are implementations of an all-solid-state battery cell having an anode current collector bonded to a lithium anode with a metal that alloys with lithium at room temperature and low or no pressure.

One implementation of an all-solid-state battery cell has a cathode on which a cathode current collector is attached, a solid electrolyte deposited on the cathode opposite the cathode current collector, an anode comprising lithium deposited onto the solid electrolyte opposite the cathode, and an anode current collector bonded to the anode opposite the solid electrolyte with a bonding layer of a metal alloyed with the lithium.

Another implementation of an all-solid-state battery cell has a free-standing cathode, a solid electrolyte on one side of the free-standing cathode, lithium deposited onto the solid electrolyte opposite the cathode, and an anode current collector bonded with a bonding layer to the lithium opposite the solid electrolyte, the bonding layer consisting of a metal alloyed with the lithium.

Another implementation of an all-solid-state battery cell has a cathode, a solid electrolyte deposited on the cathode, a lithium metal anode deposited onto the solid electrolyte opposite the cathode, and a copper anode current collector bonded to the lithium metal anode opposite the solid electrolyte with a bonding layer consisting of tin alloyed with the lithium metal anode.

Also disclosed are methods of producing the all-solid-state battery cell. An implementation of a method of producing the all-solid-state battery cell comprises providing the free-standing cathode as a substrate, depositing the solid electrolyte onto the free-standing cathode, depositing the lithium onto the solid electrolyte opposite the free-standing cathode, and bonding the anode current collector to the lithium. The bonding step comprises plating the metal onto the anode current collector and pressing the anode current collector on the lithium with a metal-coated surface contacting the lithium to alloy the metal with the lithium at room temperature.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is a schematic of an implantation of all-solid-state battery cell as disclosed herein.

### DETAILED DESCRIPTION

ASSBs, in contrast to lithium-ion batteries, are inherently safer and offer the potential for a significant increase in energy density. ASSBs do not use liquid electrolyte, which can be highly volatile and flammable. ASSBs generally are more resistant to temperature extremes, as ion conductivity of liquid electrolytes can be reduced at low temperatures and liquid electrolytes can accelerate the decomposition and deterioration of other components in the cell at high temperatures. ASSBs generally have higher energy densities, and the energy densities of ASSBs can be further increased by using lithium metal as an anode. The interface between the solid electrolyte and the lithium anode in ASSBs can effectively reduce or eliminate the growth of lithium dendrites, which can be a significant problem with lithium-ion batteries using liquid electrolytes with lithium anodes. However, different challenges can arise with ASSBs that may affect the energy density realized by ASSBs.

For conventional lithium ion batteries, cathode material and anode material are coated directly onto the respective current collectors. In some ASSBs, the cathode active material can be made free-standing, i.e., without a substrate on which the material is deposited or coated. Unlike conventional solid-state cathode materials, there is no substrate which adds volume to the battery cell without contributing to performance, resulting in a more energy dense structure. Thus, the entire thickness of the cathode active material contributes to the performance of the battery. The cathode active material itself becomes the mechanical support body for the battery cell components. In ASSBs using a free-standing cathode, such as an LiCoO₂ wafer, the other layers of the cell are sequentially deposited onto the cathode. The cathode current collector is attached to the cathode, the solid electrolyte is deposited on the other side of the cathode and the lithium anode is deposited onto the solid electrolyte. The anode current collector is then attached to the lithium anode.

Conventional bonding methods include the use of adhesive and conductive films to attach the anode current collector to the lithium anode. There are disadvantages to using adhesive and conductive films that ultimately negatively impact ASSB cell performance. A disadvantage of using adhesive or a conductive film with a lithium anode is the incompatibility of the adhesive material or the conductive film material with lithium, which can lead to poor electrical connectivity between the current collector and the lithium, resulting in reduced cycling performance and stability. Another disadvantage of adhesive or conductive films is the added thickness to the cell that results, as the typical thickness of an adhesive layer is 5 μm to 10 μm. This added thickness reduces the volumetric energy density of the cell. Yet another disadvantage of adhesive or conductive films is the requirement of higher temperature and pressure to cure the intermediate bonding layer to achieve the 5 μm to 10 μm thickness and to achieve the requisite conductivity.

Disclosed herein is an all-solid-state battery cell having an anode current collector bonded to a lithium anode with a metal that alloys with lithium at room temperature and low or no pressure. The metal is coated onto the copper anode current collector, which is then laid on the lithium anode with the metal-coated side facing the lithium. The metal forms an alloy with the lithium at room temperature, acting as a glue to adhere the current collector to the lithium anode. Pressure can be used, such as 30 psi or less, or 10 psi or less, or 2 psi or less, to ensure intimate, uniform contact between the metal and the lithium. The pressure is applied for only a short time, such as 5 minutes or less, or 3 minutes or less. A thin coating of metal, less than 1.0 μm, is sufficient for the bond. The coating can be as thin as approximately 100 nm or less. The use of the metal rather than an adhesive or conductive film reduces the impedance of contact between the anode current collector and the lithium.

The thin coating of metal required to achieve the bond, when compared to the thickness of conventional adhesives and conductive films, increases the cell volumetric energy density. The ability to create the bond at or near room temperature eliminates the need to expose the remaining layers to high temperatures, which can negatively affect the layers and/or the bond between other layers. The ability to create the bond with little or no pressure eliminates the need to expose the remaining layers to high pressures. The manufacturing process is simplified without the requirement of high temperatures and pressures.

The metal can be tin, which readily alloys with lithium. The tin does not migrate into the lithium, staying in place throughout the life of the battery cell, and ions readily pass through the tin. Other lithiophilic metals can be used that alloy and bond with lithium, including zinc, antimony, aluminum, gold, silver, magnesium, and bismuth.

The all-solid-state battery cells disclosed herein may be configured, among other parts, with: (i) a thin metal cathode current collector, such as, for instance, 10 μm Al foil (or no such current collector if the cathode is conductive enough along its outside surface to which the positive terminal may be connected); (ii) a solid electrolyte, such as, for instance, 1-3 μm thick LiPON; (iii) a thin metal anode, such as, for instance, 10-50 μm of metallic lithium; (iv) a thin metal anode current collector, such as copper; and (v) a bonding layer between the anode and the anode current collector, the bonding layer being metal, such as tin, alloyed with the metallic lithium. The elements of the battery cell may be, for example, packaged using a thin-film encapsulation of about 3 μm in thickness. An electrochemical device can have one or more solid-state battery cells. The battery cells disclosed herein can operate without any external pressure. External pressure is necessary for the operation of conventional lithium-ion batteries using liquid electrolytes.

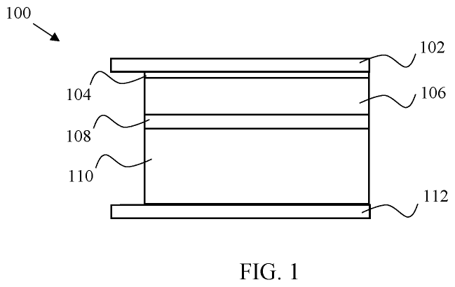

FIG. 1 is a schematic view of an example of an all-solid-state battery cell 100 as disclosed herein. The all-solid-state battery cell 100 in this example has an anode current collector 102, the bonding layer 104 as disclosed herein, an anode 106, a solid electrolyte 108, a cathode 110, and a cathode current collector 112. The layers are sequentially deposited on the cathode 110. The free-standing cathode 110 acts as a substrate, with the solid electrolyte 108 deposited onto the free-standing cathode 110, the lithium metal anode 106 deposited onto the solid electrolyte 108 opposite the free-standing cathode 110, and the anode current collector 102 bonded to the lithium metal anode 106 via the bonding layer 104. The bonding layer 104 is formed by coating, such as plating, the metal onto the anode current collector 102 and pressing the anode current collector 102 on the lithium metal anode 106 with the metal-coated surface of the anode current collector 102 contacting the lithium metal anode 106 to alloy the metal with the lithium at room temperature. A cathode current collector 112, if required, can be attached to the cathode 110 prior to depositing the other layers or after depositing the other layers. Battery stacks can be formed using both sides of the current collectors. For example, the anode current collector can be coated on both sides with the metal, each side bonded to a core stack of cathode, electrolyte and anode via a bonding layer on each side of the anode current collector.

The cathode 110 can be a free-standing cathode comprising LiCoO₂. The cathode 110 can comprise one or more lithium transition metal-based materials selected from lithium transition metal oxides and lithium transition metal phosphates. The lithium transition metal-based material may be an intercalation lithium ion compound such as lithium transition metal oxides having a general formula of LiMO₂ and LiMₓO_{y}, and lithium transition metal phosphates, having the general formula of LiMPO₄, wherein M is one or more transitional metal cations. The lithium transition metal-based material can include, as non-limiting examples, layered-type materials, such as LiCoO₂, LiNi_{1/3}Mn_{1/3}Co_{1/3}O₂ and LiNi_{0.8}Co_{0.15}Al_{0.05}O₂; olivine-type materials, such as LiFePO₄; spinel-type materials, such as LiMn₂O₄; and other similar materials. The cathode current collector 112 can be aluminum or an aluminum alloy, as non-limiting examples.

The solid electrolyte 108 can be, as non-limiting examples, lithium phosphorus oxynitride (LiPON) or other solid-state thin-film electrolytes, sulfide compounds (e.g. Argyrodite, LGPS, LPS, etc.), garnet structure oxides (e.g. LLZO with various dopants), NASICON-type phosphate glass ceramics (LAGP), oxynitrides (e.g. lithium phosphorus oxynitride or LIPON), and polymers (PEO).

The solid electrolyte layer 108 and the lithium anode 106 may be sequentially deposited using a variety of methods. These methods may include, for example, vacuum vapor phase growth methods or non-vapor phase methods. Vacuum vapor phase methods may include, for example, reactive or non-reactive RF magnetron sputtering, reactive or non-reactive DC diode sputtering, reactive or non-reactive thermal (resistive) evaporation, reactive or non-reactive electron beam evaporation, ion-beam assisted deposition, plasma enhanced chemical vapor deposition or the like. Non-vapor phase methods may include, for example, spin coating, ink-jetting, thermal spray deposition or dip coating.

It is to be understood that the terminology used herein is used for the purpose of describing particular implementations only, and is not intended to limit the scope of the disclosure. It must be noted that as used herein and in the appended claims, the singular forms “a,” “an,” and “the” include the plural reference unless the context clearly dictates otherwise. Thus, for example, a reference to “an element” is a reference to one or more elements, and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise. Unless defined otherwise, all technical and scientific terms used herein have the same meanings as commonly understood by one of ordinary skill in the art to which this invention belongs.

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. An all-solid-state battery cell, comprising:
a cathode current collector;
a cathode on which the cathode current collector is attached;
a solid electrolyte on the cathode opposite the cathode current collector;
an anode comprising lithium deposited onto the solid electrolyte opposite the cathode; and
an anode current collector bonded to the anode opposite the solid electrolyte with a bonding layer of a metal alloyed with the lithium.

2. The all-solid-state battery cell of claim 1, wherein the metal is tin.

3. The all-solid-state battery cell of claim 1, wherein the metal is one or more of tin, zinc, antimony, aluminum, gold, silver, magnesium, and bismuth.

4. The all-solid-state battery cell of claim 1, wherein the bonding layer is less than 1.0 μm.

5. The all-solid-state battery cell of claim 1, wherein the bonding layer is less than or equal to 100 nm.

6. The all-solid-state battery cell of claim 1, wherein the cathode is a free-standing LiCoO₂ wafer.

7. The all-solid-state battery cell of claim 1, wherein the anode current collector is copper.

8. An all-solid-state battery cell, comprising:
a free-standing cathode;
a solid electrolyte on one side of the free-standing cathode;
lithium deposited onto the solid electrolyte opposite the cathode; and
an anode current collector bonded with a bonding layer to the lithium opposite the solid electrolyte, the bonding layer consisting of a metal alloyed with the lithium.

9. The all-solid-state battery cell of claim 8, wherein the metal is tin.

10. The all-solid-state battery cell of claim 8, wherein the bonding layer is less than 1.0 μm.

11. The all-solid-state battery cell of claim 8, wherein the bonding layer is less than or equal to 100 nm.

12. The all-solid-state battery cell of claim 8, wherein the free-standing cathode comprises LiCoO₂.

13. The all-solid-state battery cell of claim 8, wherein the anode current collector is copper.

14. A method of producing the all-solid-state battery cell of claim 8, comprising:
providing the free-standing cathode as a substrate;
depositing the solid electrolyte onto the free-standing cathode;
depositing the lithium onto the solid electrolyte opposite the free-standing cathode; and
bonding the anode current collector to the lithium, the bonding comprising:
plating the metal onto the anode current collector; and
pressing the anode current collector on the lithium with a metal-coated surface contacting the lithium to alloy the metal with the lithium at room temperature.

15. The method of claim 14, wherein the pressing is performed at 30 psi or less to promote uniform contact.

16. The method of claim 14, wherein the all-solid-state battery cell has a cathode current collector, the method further comprising:
bonding the cathode current collector onto the free-standing cathode.

17. The method of claim 14, wherein the metal is one or more of tin, zinc, antimony, aluminum, gold, silver, magnesium, and bismuth.

18. The method of claim 14, wherein the bonding layer is less than 1.0 μm.

19. The method of claim 14, wherein the bonding layer is less than or equal to 100 nm.

20. The method of claim 14, wherein the free-standing cathode comprises LiCoO₂.
